(19) United States
(12) Patent Application Publication
(10) Pub. No.: US 2005/0265015 A1
(43) Pub. Date: Dec. 1, 2005

(54) Lighted bicycle helmet

(76) Inventor: Tracy A. Salazar, Pagosa Springs, CO (US)

Correspondence Address: JENNIFER L. BALES, MOUNTAIN VIEW PLAZA, 1520 EUCLID CIRCLE, LAFAYETTE, CO, 80026-1250, US

(21) Appl. No.: 11/129,857

(22) Filed: May 16, 2005

Related U.S. Application Data
(60) Provisional application No. 60/571,474, filed on May 14, 2004.

(51) Int. Cl. F21V 21/084

(52) U.S. Cl. 362/106

(57) ABSTRACT

A lighted bicycle helmet according to the present invention combines highly visible lights to increase bicyclist safety, a headlight to allow the bicyclist to see at night, and self contained power packs to power the lights. The helmet also includes an on/off switch and a power adapter with a connection to allow the power packs to be recharged.

This application claims the benefit of U.S. Provisional Application No. 60/571,474 filed May 14, 2004 and incorporates that application herein by reference.

### BACKGROUND OF THE INVENTION

1. Field of the Invention

The present invention relates to lighted bicycle helmets. In particular, the present invention relates to lighted bicycle helmets with front and rear lights and self contained power supplies.

2. Description of the Prior Art

Bicycle helmets are worn by bicyclists to prevent head injury in case of accident. They have also been used to increase the visibility of the bicyclist, by incorporating elements like reflectors and lights. See, for example, U.S. Pat. No. 6,464,369, which teaches a helmet with a light for increasing visibility, which is turned on when the wearer dons the helmet.

A need remains in the art for a bicycle helmet which combines highly visible lights to increase bicyclist safety, a headlight to allow the bicyclist to see at night, and self contained means to power the lights.

### SUMMARY OF THE INVENTION

An object of the invention is to provide a bicycle helmet which combines highly visible lights to increase bicyclist safety, a headlight to allow the bicyclist to see at night, and self contained power packs to power the lights. In the preferred embodiment, the helmet also includes an on/off switch.

Preferably, the lights are powered by rechargeable batteries. This removes the need for any wires leading from the helmet to the bicycle, a backpack, or any other element. In general, an AC power adapter includes a connection for plugging in the helmet to recharge the batteries. As a feature, an LED indicates when the power in the batteries is low. Another feature is a charging indicator light.

The high visibility lights may comprise bright red LEDs or strobe lights.

### BRIEF DESCRIPTION OF THE DRAWINGS

FIG. 1 is a side isometric view showing the right side of a preferred embodiment of a helmet according to the present invention.

FIGS. 2 A-L are photographs of a prototype of the present invention from a variety of views.

FIG. 3 is a side isometric view showing the left side of a preferred embodiment of a helmet according to the present invention.

FIG. 4 is a plan view showing the top of a preferred embodiment of a helmet according to the present invention.

FIG. 5 is an isometric view showing the back of a preferred embodiment of a helmet according to the present invention.

FIG. 6 is a block diagram indicating the electrical connections within a first embodiment of the helmet.

FIG. 7 is a block diagram indicating the electrical connections within a second embodiment of the helmet.

### DETAILED DESCRIPTION OF THE PREFERRED EMBODIMENTS

Bicycle helmets according to the present invention include both high visibility safety lights to make the bicyclist more visible to others and a headlight to allow the bicyclist to see at night. These lights are powered by batteries contained within the helmet itself, so that no wires lead from the helmet to a backpack or the like.

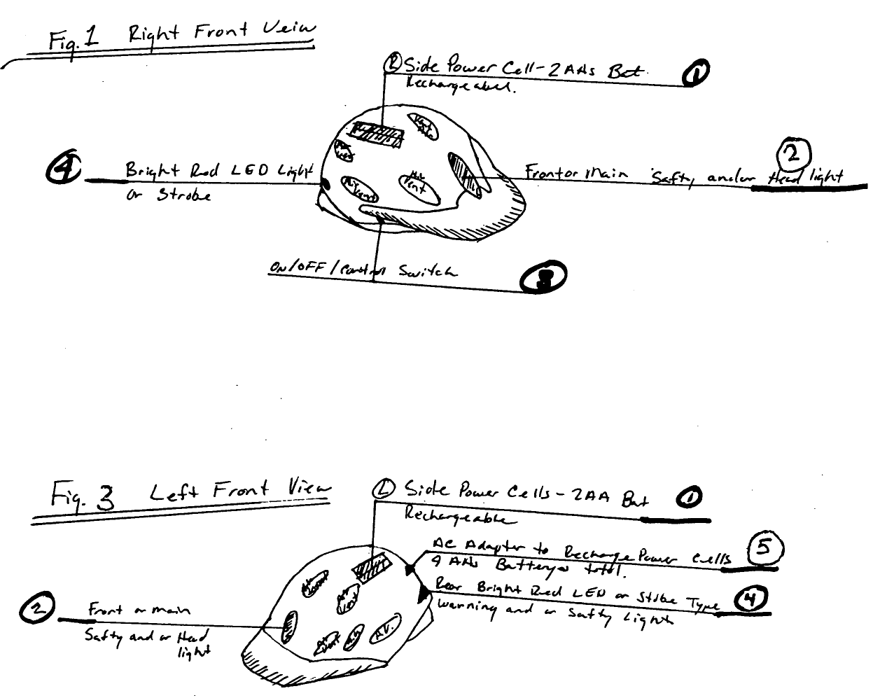

FIG. 1 is a side isometric view showing the right side of a preferred embodiment of a helmet 100 according to the present invention, slightly from the front. Power cell 1 generally includes two double A rechargeable batteries. Preferably power cell 1 is embedded into helmet 100, and is flush with the helmet. Front headlight 2, powered by power cell 1, is also generally flush with the front surface of helmet 100. Preferably, it is a high intensity head lamp which allows the bicyclist (not shown) to see at night. Front light 2 can alternatively be a high visibility light such as a flashing strobe light or the like.

On/off control switch 3 generally turns front light 2 on and off. Alternatively, it may also control visibility lights 4. Visibility lights 4 are generally bright red LEDs or strobe lights, intended to be highly visible to car drivers and others in the environment of the bicyclist.

The on/off switch on the first prototype powers the front headlight/safety light and the rear facing bright LED, safety lights simultaneously. Other embodiments use a variable on/off Power Control Switch. This allows the wearer to control which light(s) the wearer needs. As an example, when the bicyclist is going down the road, the switch might be operated to select the front head/safety light and the rear bright red LED. When the wearer is taking a break, the switch might be operated to select only a map reading light that angles down from the helmet.

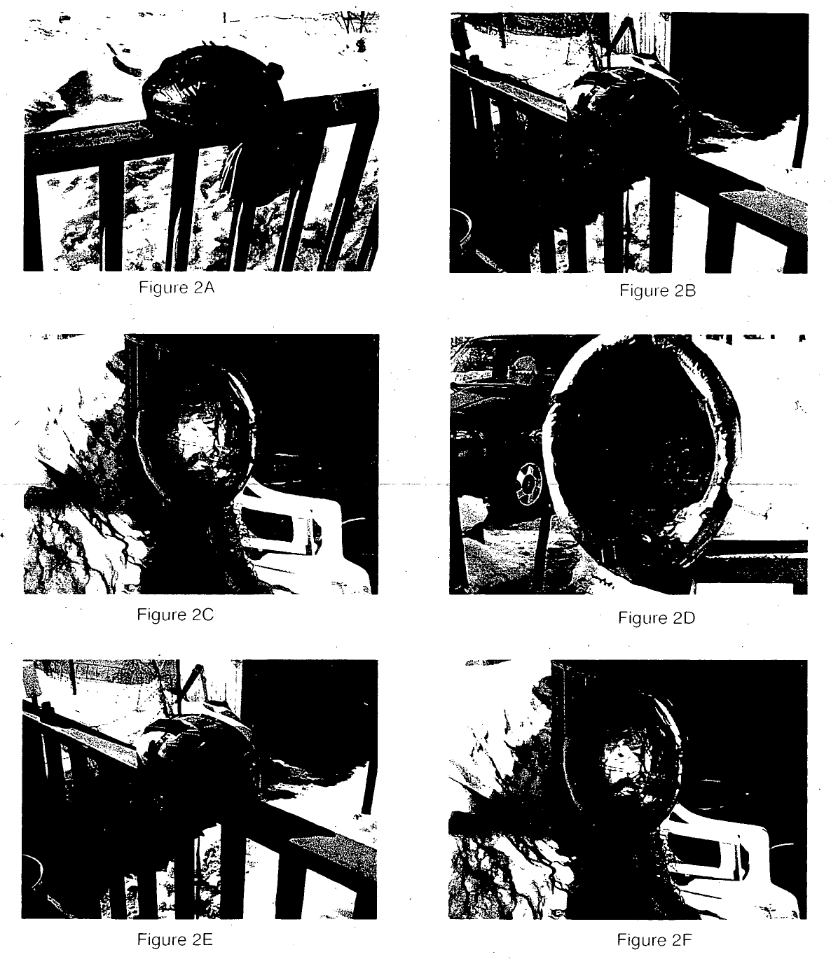

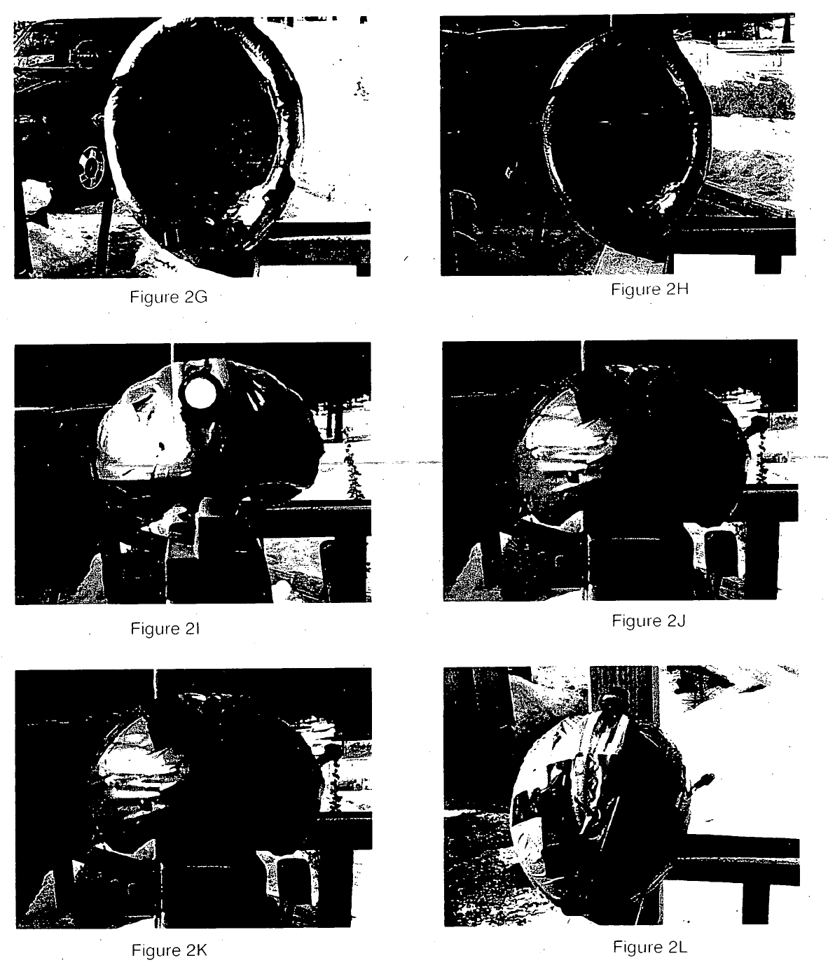

FIGS. 2 A-L are photographs of a prototype of the present invention from a variety of views. FIG. 2A shows the right side of helmet 100, slightly from the back. FIGS. 2B and 2E show the left side of helmet 100, slightly from the front. FIGS. 2C, 2D, 2F, 2G and 2H show the inside of helmet 100, from underneath. FIG. 21 shows helmet 100 from the front. FIG. 2J and 2K show helmet 100 from the rear. FIG. 2L shows helmet 100 from the top.

FIG. 3 is a side isometric view showing the left side of helmet 100. This view is less skewed to the front than FIG. 1, allowing AC adapter 5 to be seen. A second power cell 1 is embedded on the left side of helmet 100 and a second high visibility light 4 is placed near the rear of the left side.

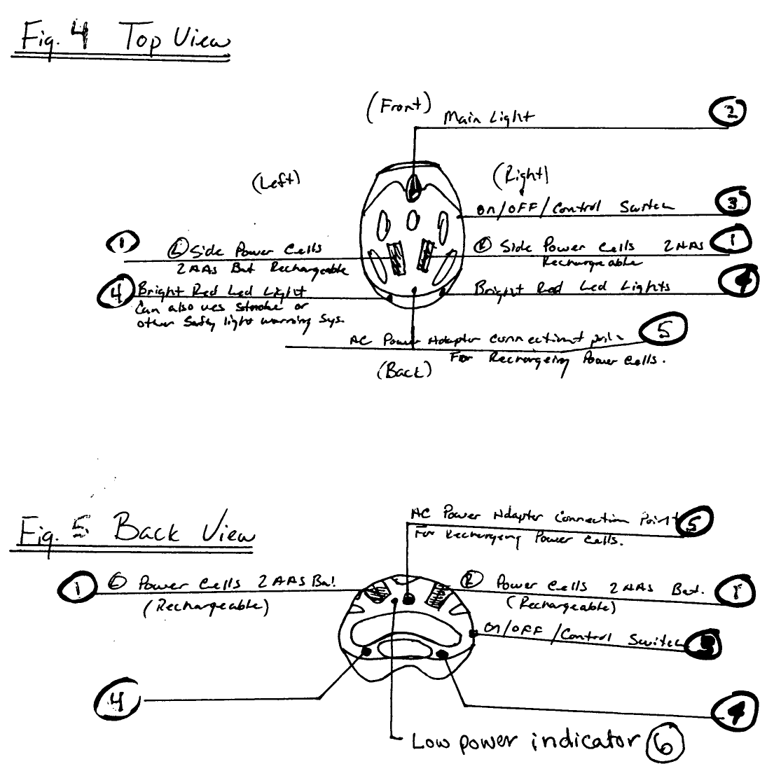

FIG. 4 is a is plan view showing the top of helmet 100. In this view, both high visibility lights 4 and power cells 1 can be seen.

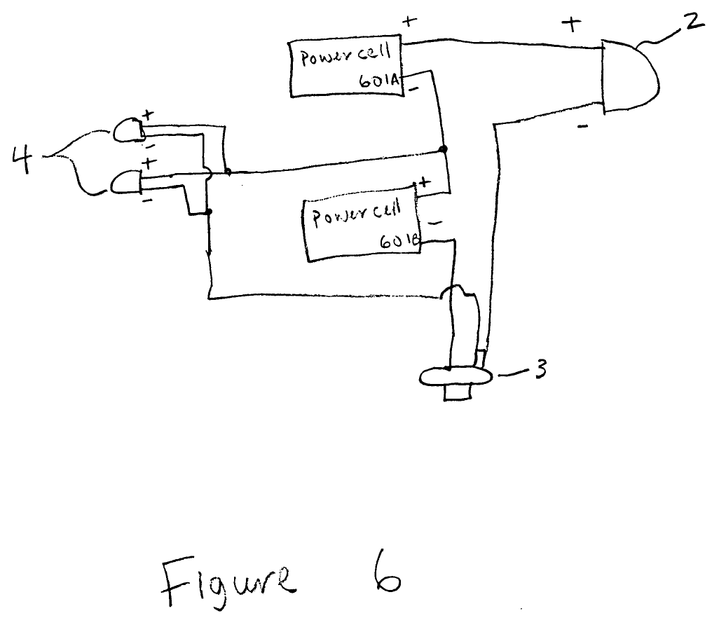

FIG. 5 is an isometric view showing the back of helmet 100. This view shows best the power adapter connection point 5, where helmet 100 is plugged in between uses to recharge power cells 1. In the preferred embodiment, a low power indicator 6 (for example a small red LED) indicates when power cells 1 are running low and need to be recharged.

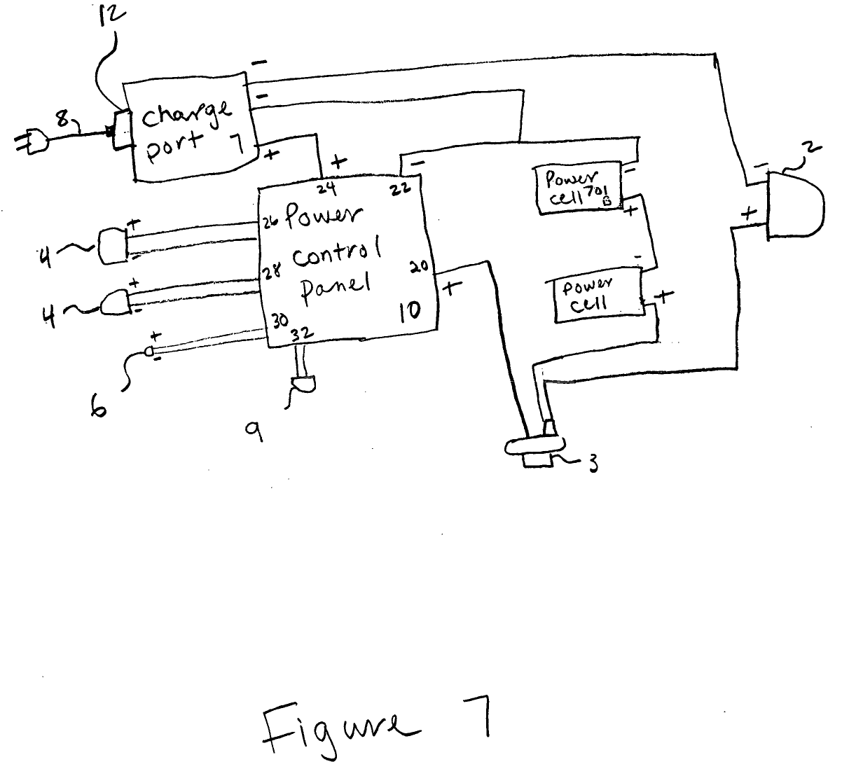

FIG. 6 is a block diagram indicating the electrical connections within a first embodiment of helmet 100, with removable batteries 601. Batteries 601 may be rechargeable or nonrechargeable, but must be removed from helmet 100 for replacement or recharging. When in place, they are hardwired to the lighting elements. Batteries 601 may comprise 4 AA batteries. Power cell 601A and power cell 601 B each comprise two AA batteries in series in this case. Other types of batteries may be used, but larger batteries result in more weight in the helmet.

AA batteries provide 1.5 Volts each. As an alternative, 4 Ni-Cad rechargeable batteries may be used, at 1.6 Volts each, providing combined 7000 mA for approximately four hours of use.

In the embodiment of FIG. 6, power cells 601 are connected in series. The positive terminal of power cell 601A connects to front light 2. The negative terminal of power cell 601A connects to the positive terminal of power cell 601 B and also leads to high visibility lights 4 as described below. The negative terminal of power cell 601 B leads to on/off switch 3, which also leads to the negative terminal of front light 2. Hence, when switch 3 is switched on, the circuit comprising power cells 601A, 601B and front light 2 is complete, and front light 2 turns on.

The mid-voltage point between the negative terminal of power cell 601A and the positive terminal of power cell 601B leads to the positive terminal of high visibility lights 4. The negative terminals of lights 4 lead to the on/off switch 3. Hence, when switch 3 is turned on, connecting the circuit, lights 4 also light.

In one embodiment, front light 2 is a mini-krypton flashlight lamp with rated voltage 2.5V, rated current 300 mA, base size and style 1″ wire terminals, brightness 0.6CP, and average life about eight hours. High intensity lights 4 are red high brightness LED requiring 2.1V at 10 mA. Other possibilities include strobe, flasher, or map reading lights. Wiring might comprise red and black 22 gauge solid wire insulated to 80 degrees C., 1/64″ PVC. Smaller gauge wiring may be preferred for some components. Preferably connection points are soldered and coated in water resistant nonconducting silicon glue or the like, though other locking type connectors can be used. The preferred embodiments withstand 300 G impact and submersion in 25′ of water.

On/off switch 3 could be a SPST Push-On/Off red switch, contacts rated 3A at 250VAC, 1A at 250VAC. The switch in one embodiment when ON with all of the lights (front and back) operating simultaneously uses approximately 4.6 volts at 310 mA.

FIG. 7 is a block diagram indicating the electrical connections within a second embodiment of helmet 100, with permanent rechargeable power cells 601 B and power control panel 10. It is similar to the embodiment of FIG. 6, except that it includes connections for recharging power cells 701, a low power indicator 6, and on/off switch 3 connects positive terminals rather than negative terminals, for convenience.

Power Control Panel 10 is the brains of the system. It senses when on/off switch 3 is turned on at port 20. In response to this signal, Power Control Panel 10 connects the positive terminal of of power cell 701 A (via switch 3) to high intensity lights 4, and connects their negative terminals to ground, illuminating the lights. It also connects the negative terminal of power cell 701 B to ground. Power cells 701A and 701 B are then connected in series. The positive terminal of power cell 701A connects to switch 3, which also connects to the positive terminal of front light 2. The negative terminal of front light leads to the ground of charge port 7. Hence when switch 3 is turned on, front light 2 illuminates. The negative terminal does not connect directly to the ground of charge port 7. Rather, it connects to the power control panel where it is connected to resistors, connectors, power reducers, etc.

Charge port 7 allows rechargeable power cells 701 to be recharge via a wall socket connection or the like. Charge port 7 includes an AC adapter 12 which converts the AC current to DC current used to recharge power cells 701. When power cord 8 is plugged in, charge port 7 signals Power Control Panel 10, via port 24, to recharge cells 701. Positive voltage from charge port 7 is connected to the positive terminal of power cell 701A, and the negative terminal of power cell 701B is connected to the negative side of charge port 7, allowing cells 701 to be recharged. The switch needs to be in the OFF position to charge.

Power Cell Panel 10 also detects when power cells 701 are nearly discharged (because their voltage begins to drop) and turns on low power indicator 6 when this occurs. Indicator 6 is typically a low power LED. In alternative embodiments, indicator 6 may blink while the power cells are charging and show a solid color once the cells are fully charged.

Power Cell Panel 10 also controls charging indicator 9. Indicator 9 typically blinks while the power cells are charging and show a solid color once the cells are fully charged. Low power indicator 6 and charging indicator 8 may be physically combined to use the same LED.

Power Control Panel 10 is a microchip or computer board. Its design varies slightly depending upon the specific use to which the helmet will be put. For example, panel 10 may be modified to power other element like audio or video recorders or players, GPS, motion detector, emergency beckon or personal locator, or the like.

In one embodiment, all of the components, other than the helmet itself, combine for a weight under 6 ounces.

Those skilled in the art will also appreciate other variations in the present invention that are not specifically shown in a drawing. For example, the helmet of the present invention is useful not just for bicyclists, but also for snow boarders, skiers, skate boarders, and the like. Front head lamp 2 can be replaced by another high visibility light like lights 4. This is useful in helmets for snow boarders and the like who do not need to see at night.

Future power cells could include flexible rechargeable power cells or micro/nano rechargeable power cells. Instead of charge port 7 being connected to a wall socket, it could be connected to a solar generator for generating electricity from natural or artificial light.

The helmets according to the present invention are useful for a variety of purposes other than bicycle helmets. For example, a ski patrol helmet might include short range communication capability and a personal locator, while a ski helmet would likely have more bright indicator lights and leave out the front lamp. A police officer on bicycle patrol might provide a powerful front lamp and a video recorder.

1. A lighted helmet for use by a wearer comprising:
a front light for selectively providing light for the wearer to see by;
a rear light for selectively causing the wearer to be visible;
a power supply entirely contained within the helmet; and
a switch for selectively illuminating the front light, the rear light, or both;
wherein the power supply is rechargeable and contained within the helmet.
